(19) United States
(12) Patent Application Publication
(10) Pub. No.: US 2007/0052667 A1
(43) Pub. Date: Mar. 8, 2007

(54) Bi-stable display with accurate greyscale and natural image update

(75) Inventors: Guofu Zhou, Best (NL); Neculai Ailenei, Landgraaf (NL); Mark T. Johnson, Veldhoven (NL); Jan van de Kamer, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/573,309

(22) PCT Filed: Sep. 24, 2004
(86) PCT No.: PCT/IB04/51853

§ 371 Date: Mar. 24, 2006

Related U.S. Application Data
(60) Provisional application No. 60/506,886, filed on Sep. 29, 2003.

(51) Int. Cl. G09G 3/34

(52) U.S. Cl. 345/107

(57) ABSTRACT

An accurate greyscale is obtained with more natural image updates when updating a display (310) in a bi-stable electronic reading device (300,400), such as one using an electrophoretic display, by applying a first shaking pulse (S1) to the display, applying a first portion (R1) of a reset pulse to the display following the first shaking pulse (S1), applying a second shaking pulse (S2) to the display following the first portion (R1), and applying a second portion (R2) of the reset pulse to the display following the second shaking pulse (S2). The first portion may have a standard reset duration, while the second portion has an over-reset duration. A visual shock effect is avoided which would otherwise as applied after the entire reset pulse.

The invention relates generally to electronic reading devices such as electronic books and electronic newspapers and, more particularly, to a method and apparatus for updating an image with improved image quality using a drive waveform that includes shaking pulses.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

In a particular aspect of the invention, a method for updating an image on a bi-stable display includes applying at least a first shaking pulse to the bi-stable display, applying a first portion of a reset pulse to the at least a portion of the bi-stable display following the at least a first shaking pulse, applying at least a second shaking pulse to the at least a portion of the bi-stable display following the first portion of the reset pulse, applying a second portion of the reset pulse to the at least a portion of the bi-stable display following the at least a second shaking pulse, and finally applying a driving pulse to send the display to a desired intermediate optical state.

A related electronic reading device and program storage device are also provided.

The non-pre-published patent application (applicants' docket no. PHNL030091), filed as European patent application 03100133.2, discloses that picture quality can be further improved by extending the duration of the reset pulse that is applied before the drive pulse. In particular, an over-reset pulse is added to the reset pulse, where the over-reset pulse and the reset pulse together have an energy which is larger than that required to bring the pixel into one of two limit optical states. The duration of the over-reset pulse may depend on the required transition of the optical state. Unless explicitly mentioned, for the sake of simplicity, the term reset pulse may cover both the reset pulse without the over-reset pulse or the combination of the reset pulse and the over-reset pulse in accordance with this invention. By using the reset pulse, the pixels are first brought into one of two well-defined limit states before the drive pulse changes the optical state of the pixel in accordance with the image to be displayed. This improves the accuracy of the grey levels. For example, if black and white particles are used, the two limit optical states are black and white. In the limit state black, the black particles are at a position near the transparent substrate and, in the limit state white, the white particles are at a position near the transparent substrate.

A shaking pulse is defined as a voltage pulse with a voltage level having an energy (or a duration, if the voltage level is fixed) sufficient to release particles present in one of the extreme positions, but insufficient to enable the particles to reach the other one of the extreme positions. The shaking pulse increases the mobility of the particles such that the reset pulse or diving pulse has an immediate effect. If the shaking pulse comprises more than one preset pulse, each preset pulse has the duration of a level of the shaking pulse. For example, if the shaking pulse has successively a high level, a low level and a high level, this shaking pulse comprises three preset pulses. If the shaking pulse has a single level, only one preset pulse is present. The pixel image history effect is significantly reduced by using a shaking pulse or a series of shaking pulses, leading to an improvement of the image quality.

In the drawings:

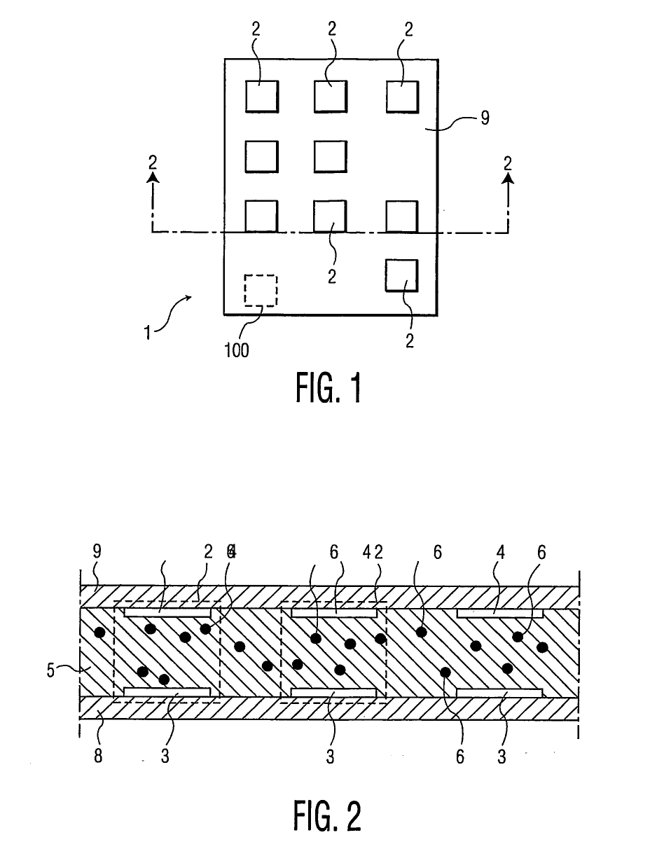

FIG. 1 shows diagramatically a front view of an embodiment of a portion of a display screen of an electronic reading device;

FIG. 2 shows diagramatically a cross-sectional view along 2-2 in FIG. 1;

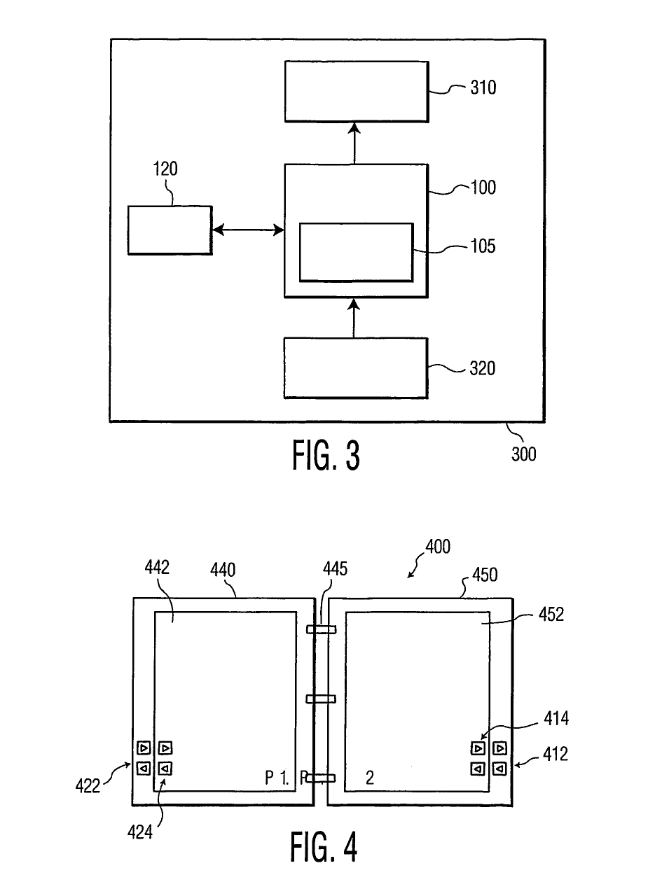

FIG. 3 shows diagramatically an overview of an electronic reading device;

FIG. 4 shows diagramatically two display screens with respective display regions;

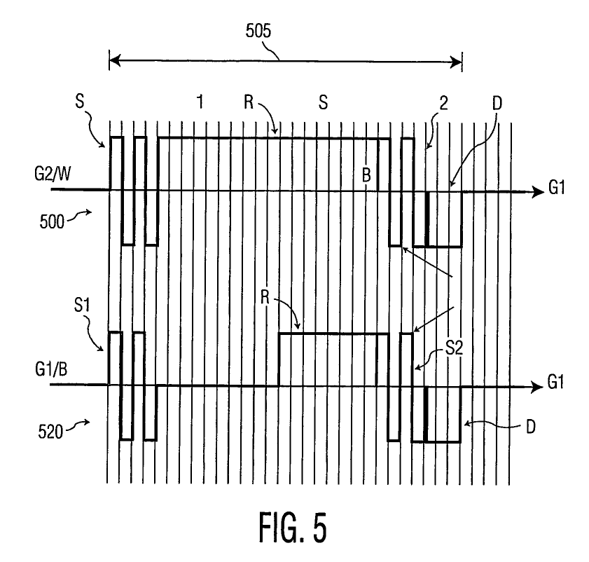

FIG. 5 illustrates waveforms in which second shaking pulses are applied to a bi-stable display following a reset pulse, resulting in a shock effect;

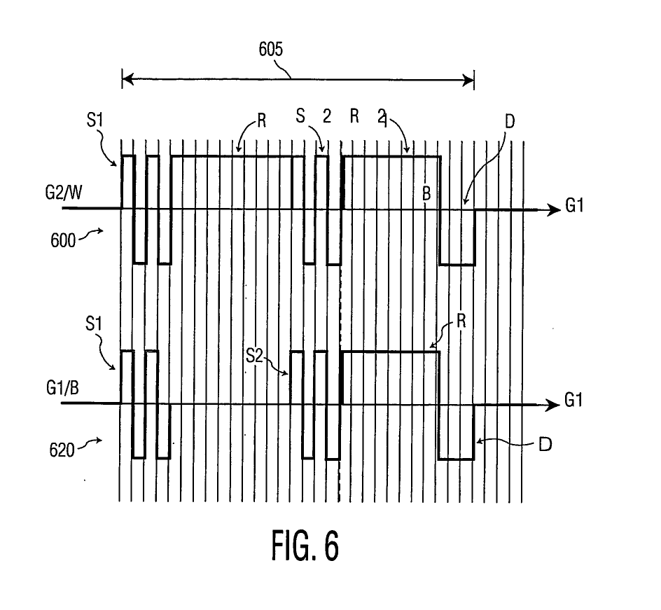

FIG. 6 illustrates waveforms in which second shaking pulses are applied to a bi-stable display between first and second portions of a pulse;

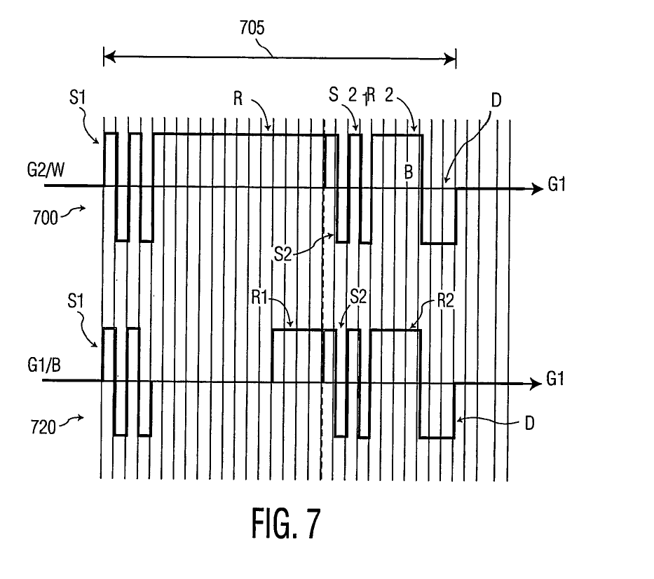

FIG. 7 illustrates waveforms in which second shaking pulses are applied to a bi-stable display between first and second portions of a reset pulse, including for a short color transition;

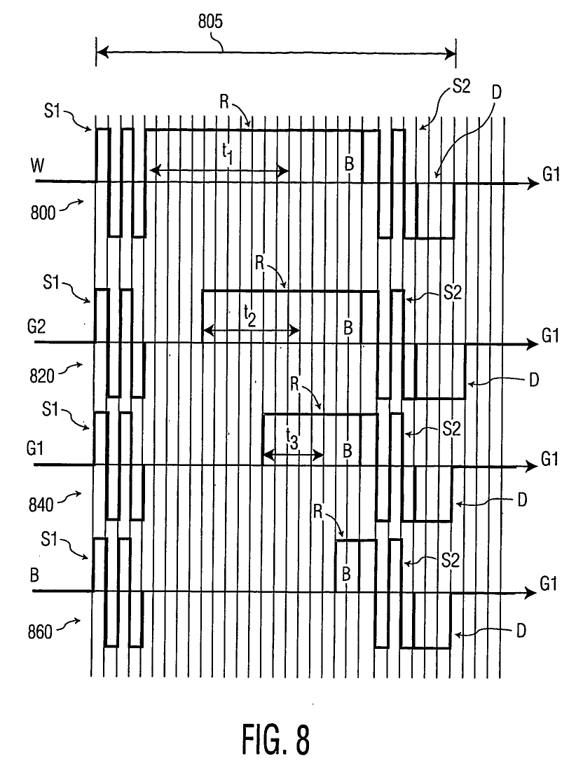

FIG. 8 illustrates waveforms in which second shaking pulses are applied to a bi-stable display following a reset pulse, resulting in a shock effect;

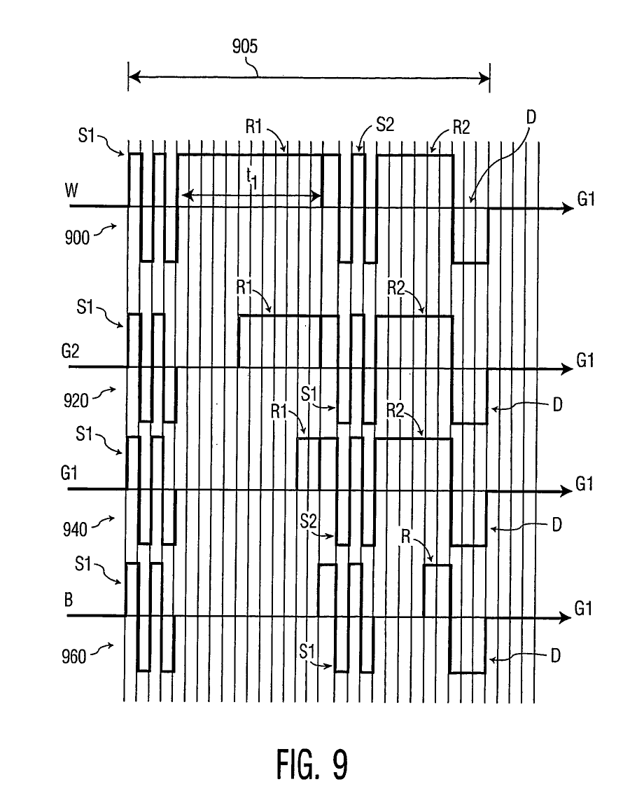

FIG. 9 illustrates waveforms in which second shaking pulses are applied to a bi-stable display between a first, standard portion of a reset pulse, and a second, over-reset portion of the reset pulse;

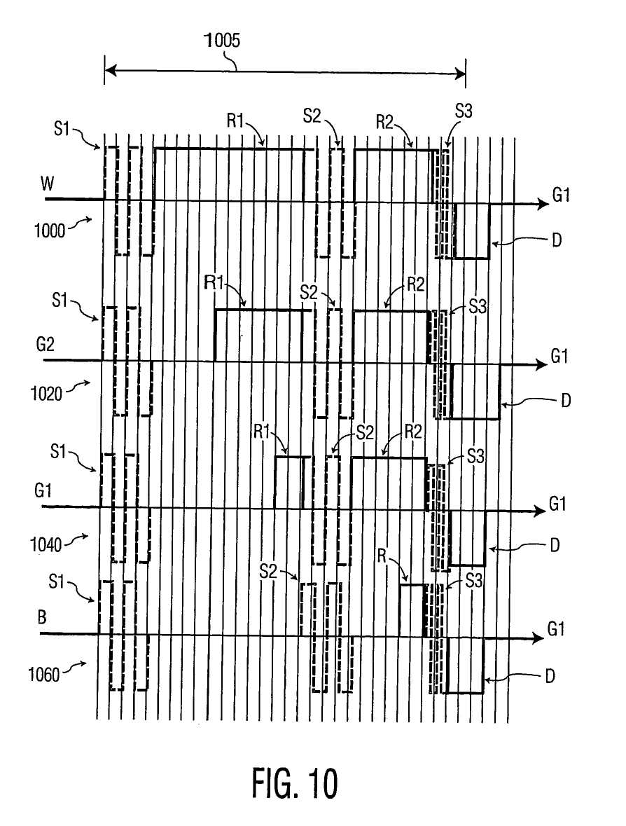

FIG. 10 illustrates waveforms corresponding to those in FIG. 9, but where third shaking pulses are applied after the over-reset portion of the over-reset pulse; and

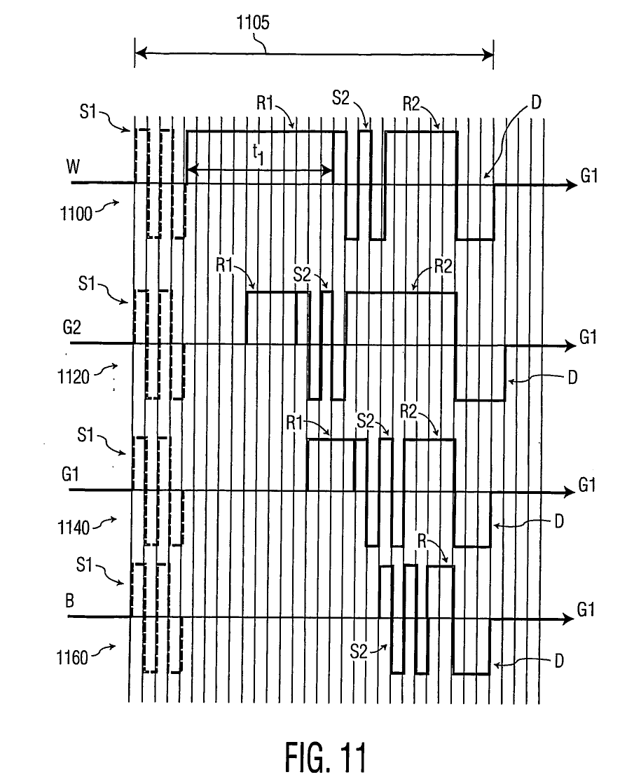

FIG. 11 illustrates waveforms corresponding to those in FIG. 9, but where the second shaking pulses are placed at any timing in each waveform and the timing in different waveforms is different (example of software shaking).

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control 100 controls the potential difference of each picture element 2 to create a desired picture, e.g., images and/or text, in a full display screen. The full display screen is made up of numerous picture elements that correspond to pixels in a display.

FIG. 3 shows diagramatically an overview of an electronic reading device. The electronic reading device 300 includes the control 100, including an addressing circuit 105. The control 100 controls the one or more display screens 310, such as electrophoretic screens, to cause desired text or images to be displayed. For example, the control 100 may provide voltage waveforms to the different pixels in the display screen 310. The addressing circuit provides information for addressing specific pixels, such as row and column, to cause the desired image or text to be displayed. As described further below, the control 100 causes successive pages to be displayed starting on different rows and/or columns. The image or text data may be stored in a memory 120. One example is the Philips Electronics small form factor optical (SFFO) disk system. The control 100 may be responsive to a user-activated software or hardware button 320 that initiates a user command such as a next page command or previous page command.

The control 100 may be part of a computer that executes any type of computer code devices, such as software, firmware, micro code or the like, to achieve the functionality described herein. Moreover, the memory 120 is a program storage device that tangibly embodies a program of instructions executable by a machine such as the control 100 or a computer to perform a method that achieves the functionality described herein. Such a program storage device may be provided in a manner apparent to those skilled in the art.

Accordingly, a computer program product comprising such computer code devices may be provided in a manner apparent to those skilled in the art. The control 100 may have logic for periodically providing a forced reset of a display region of an electronic book, e.g., after every x pages are displayed, after every y minutes, e.g., ten minutes, when the electronic reading device is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame 405 around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. In any case, the invention can be used with each display region to reduce image retention effects and to improve the smoothness of the image update.

Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Discussion of Improving Greyscale Accuracy and Smoothness of Image Update

One of the major challenges in the research and development of a bi-stable display such as an electrophoretic display is to achieve accurate grey levels, which are generally created by applying voltage pulses for specified time periods. The accuracy of the greyscale is strongly influenced by image history, dwell time, temperature, humidity, lateral inhomogeneity of the electrophoretic foils, and other factors. The accurate grey levels can be achieved using a rail-stabilized approach, which means that the grey levels are always achieved either from reference black or from reference white state (the two rails or extreme greyscale levels). In particular, the current grey level is driven to one of the rails using a reset pulse, and a subsequent drive pulse drives the pixels in the bi-stable display to the desired new grey level. One or more pixels may be considered to form a portion of the bi-stable display.

From the non-pre-published patent applications (applicants' docket nos. PHNL020441 and PHNL030091), filed as European patent applications 02077017.8 and 03100133.2, respectively, image retention can be minimized by using preset pulses (also referred to as the shaking pulse). Preferably, the shaking pulse comprises a series of AC-pulses; however, the shaking pulse may comprise a single preset pulse only. The pre-published patent applications are directed to the use of shaking pulses, either directly before the drive pulses, or directly before the reset pulses. As described at the outset, the non-pre-published patent application having applicants' docket no. PHNL030091 further discloses that the picture quality can be improved by extending the duration of the reset pulse that is applied before the drive pulse by adding an over-reset pulse to the reset pulse. The drive pulse has an energy to change the optical state of the pixel to a desired level which may be in-between the two limit optical states. Also the duration of the drive pulse may depend on the required transition of the optical state.

The non-prepublished patent application PHNL030091 further discloses in an embodiment that the shaking pulse precedes the reset pulse. Each level (which is one preset pulse) of the shaking pulse has an energy (or a duration if the voltage level is fixed) sufficient to release particles present in one of the extreme positions, but insufficient to enable said particles to reach the other one of the extreme positions. The shaking pulse increases the mobility of the particles such that the reset pulse has an immediate effect. If the shaking pulse comprises more than one preset pulse, each preset pulse has the duration of a level of the shaking pulse. For example, if the shaking pulse has successively a high level, a low level and a high level, this shaking pulse comprises three preset pulses. If the shaking pulse has a single level, only one preset pulse is present.

The complete voltage waveform that has to be presented to a pixel during an image update period is referred to as the drive voltage waveform. The drive voltage waveform usually differs for different optical transitions of the pixels.

The driving technique using an over-reset voltage pulse has been found to be most promising for driving an electrophoretic display. An over-reset pulse is a reset pulse whose duration is more than sufficient to move the particles of the bi-stable display from the present color state to an extreme color state. An over-reset can improve the image quality. Note that the pulse sequence or waveform can be applied to individual pixels in the display using a completely data-dependent waveform. In this case, the shaking pulses are referred to as “software” shaking pulses. The software shaking pulses are part of the individual waveforms and can be positioned/timed freely in each waveform. Or, the pulse sequence can be applied to all pixels in the display using a waveform comprising data-independent portions such as shaking pulses. In this case, the shaking pulses are applied on all pixels of the entire display or of the entire sub-display at the same time moment during an image update period independent of the image data to be displayed on individual pixels. So, the shaking pulses in all drive waveforms are aligned in time, increasing the image update efficiency. When a group of the lines/rows is simultaneously addressed, these aligned shaking pulses may have a shorter frame time and such shaking pulses are referred to as “hardware” shaking pulses. The present invention can be used in all above cases.

This technique is schematically shown in FIG. 5 for image transitions from light grey (G2) or white (W) to dark grey (G1) (waveform 500), and from dark grey (G1) or black (B) to dark grey (G1) (waveform 520). The total image update time is indicated at 505. The pulse sequence may include four portions: a first shaking pulse (S1), a reset pulse (R), a second shaking pulse (S2) and a greyscale driving pulse (D). Transitions to the G1 state from W, G2, G1 and B are realized using two types of pulse sequences that include are set for resetting the display. In particular, a long sequence is used for the transitions from G2 or W to G1, and a short sequence is used for the transitions from G1 or B to G1. The long sequence refers to the fact that the particles in the bi-stable display have to travel a relatively longer distance when transitioning from the lighter colors G2 and W to the darker color G1, compared to particles that transition from the darker colors G1 and B to the darker color G1 in a short sequence. A shorter reset duration is used for the short sequence.

A disadvantage of this approach is the long delay between creating the intermediate image (e.g., the reset state) and introducing the grey levels into the display. The delay results from the duration of the continuous reset pulse and the second shaking pulse (S2). To ensure the image quality, an over-reset pulse is usually added to the reset pulse, where the over-reset pulse and the reset pulse together have an energy which is larger than required to bring the pixel into one of two limit optical states. The duration of the over-reset pulse may depend on the required transition of the optical state. By using the reset pulse, the pixels are first brought into one of two well-defined limit states before the drive pulse changes the optical state of the pixel in accordance with the image to be displayed. The addition of the over-reset pulse ensures that the reference intermediate state is well-defined and the accuracy of the desired grey levels is improved. However, this over-reset pulse does not induce any visual optical change. Also, the shaking pulses would not induce any visible optical change. The over-reset together with the shaking pulse results in a long dead period during which no visible optical change is observed by a user. The delay results in a visually abrupt introduction of the grey levels (e.g., a shock effect), which is unacceptable to the user. In particular, when the shaking pulses are aligned in time in all waveforms, which is highly desired to enhance the update efficiency, this shock effect becomes more serious. The shock/sudden effect is further increased when the over-reset portion is also aligned in time in all waveforms.

In the present invention, improved rail-stabilized waveforms are proposed for an electrophoretic display with at least a two-bit greyscale. A two-bit greyscale includes four greyscale levels, i.e., Black (B), Dark grey (G1), Light grey (G2) and White (W). In one aspect of the invention, the second set of shaking pulses is applied well before completion of the entire reset pulse, independent of the image update sequences. In this way, accurate greyscale is obtained with more natural image updates. The reset pulse includes a standard reset portion followed by an over-reset portion. The standard reset portion has a duration that is sufficient to drive the particles in the bi-stable display from their current position to one of the extreme, e.g., black or white, rail positions. The over-reset portion does not result in a change in brightness, but is necessary for reducing image retention and increasing greyscale accuracy. The delay time caused by the over-reset portion in long sequences can be partially compensated for by the continuous brightness change in shorter sequences. To illustrate the most severe situation, the invention addresses the problem that the delay induced by the second shaking pulses is data independent, resulting in a large shock effect when the time period during which no optical change in the pixels occurs is too long.

FIG. 6 illustrates waveforms in which second shaking pulses are applied to a bi-stable display between first and second portions of a reset pulse. The total image update time is indicated at 605. In particular, the waveform 600 of FIG. 6 overcome the problem of the shock effect in the waveforms FIG. 5 by providing the second shaking pulse (S2) after a first portion (R1) of the reset pulse, and before a second portion (R2) of the reset pulse. The waveforms 600 and 620 are provided for a display having at least a two-bit greyscale. In the waveform 620, the second shaking pulse (S2) is placed directly prior to the start of the reset pulse (R) in the short sequence. Note that the ending points of the second shaking pulse (S2) in the waveforms 600 and 620 are time-aligned. In other words, the starting point of the second reset portion (R2) in waveform 600 and the starting point of the reset pulse (R) in waveform 620, are time-aligned. Usually, for the pixels requiring the long sequence for an image update, brightness will stop changing after about half of the entire reset pulse is complete, whereas the pixels requiring a shorter image update time are immediately switched on. In order to spread the shock effect and obtain a smooth picture, the second shaking pulses (S2) are placed prior to the start of the reset pulse (R) in short sequences. In this way, the greyscale accuracy is also improved. The second shaking pulses (S2) are data-independent in most cases, which means the same shaking pulses are applied to all pixels in the bi-stable display.

FIG. 7 illustrates waveforms in which second shaking pulses are applied to a bi-stable display between first and second portions of a reset pulse, including for a short color transition. The total image update time is indicated at 705. Pulse width modulation driving is used. In particular, for waveform 700, a second shaking pulse (S2) is applied between first reset portion (R1) and the second reset portion (R2). In waveform 720, the second shaking pulse (S2) is placed after a first portion (R1) of the reset pulse for a short sequence. Also, note that the starting points of the second shaking pulses (S2) in waveforms 700 and 720 are time-aligned. In other words, the ending points of the first reset portions (R1) in waveforms 700 and 720 are time-aligned.

FIG. 8 illustrates waveforms in which second shaking pulses are applied to a bi-stable display following a reset pulse, resulting in a shock effect. The total image update time is indicated at 805. Four types of pulse sequences are used for the four different transitions to G1 state from W, G2, G1, B (waveforms 800, 820, 840 and 860, respectively). Each sequence includes a first shaking pulse (S1), a reset pulse (R), a second shaking pulse (S2) and a driving pulse (D). In waveform 800, t1 indicates the standard reset pulse time, which is the time that is sufficient to drive the particles in the bi-stable display from their current position to one of the extreme, e.g., black or white, rail positions. The standard reset pulse times for waveforms 820 and 840 are t2 and t3, respectively. In waveform 860, the display is already at one of the rails, e.g., black, so no standard reset pulse is used. Instead, only an over-reset portion is used. The second part of the reset pulse represents the over-reset pulse, which can have a different duration in different waveforms, depending on the image transition.

Note that the ending points of the reset pulses (R) and the starting point of the second shaking pulses (S2) are time-aligned. However, since the shaking pulses (S2) follow the entire reset pulse (R), the shock effect can occur. An improved technique is described below.

FIG. 9 illustrates waveforms in which second shaking pulses (S2) are applied to a bi-stable display between a first portion (R1) of a reset pulse, and a second portion (R2) of the reset pulse. The total image update time is indicated at 905. In each waveform, the reset pulse consists of two parts: the standard reset pulse and the over-reset pulse. As mentioned above, the standard reset time is proportional to the distance required for the particles to move to one of the rails. The distance corresponds to the time t₁, t₂ and t₃ for transitions to G1 from W, G2 and G1, respectively, in waveforms 900, 920 and 940, respectively. The over-reset time in each waveform is largely determined by when the accurate grayscale is achieved and image retention is minimized, and can be different for different waveforms corresponding to different greyscale transitions. The timing of the second shaking pulse can be experimentally determined, e.g., by measuring the optical response for each transition upon the application of the drive waveform. The measured curves for different transitions are compared with the variable timing for placing the second shaking pulses. In this example, the second shaking pulse (S2) is placed directly after the completion of the standard reset pulse in the longest waveform, i.e., the transition from W to G1. The advantage of this approach is that part of the standard reset pulse in the relatively short waveforms, e.g., in transitions from G2 to G1 and from G1 to G1, is complete after the second shaking pulse, at which time the pixels receiving the longest waveform W to G1 do not have any visible optical effects. The continuous change on other pixels receiving the relatively short waveforms in this period will give the user a smooth impression of the overall display update. It is also possible to place the second shaking pulse (S2) prior to the second longest reset pulse, depending on the quality of the picture and the experimentally measured results.

FIG. 10 illustrates waveforms 1000, 1020, 1040 and 1060 corresponding to waveforms 900, 920, 940 and 960, respectively, in FIG. 9, but where a third set of shaking pulses (S3) are applied after the reset pulse. The total image update time is indicated at 1005. In particular, a third shaking pulse (S3) is added between the end of the reset pulse (R or R2) and the start of the driving pulse (D). This additional shaking pulse (S3) is much shorter in duration than the “common” first and second shaking pulses (S1 and S2) to avoid a large delay in the image update time. Moreover, the additional shaking pulse (S3) is generally needed only when greyscale accuracy or image retention is qualified, e.g., in the case of an ink material having a strong image retention.

FIG. 11 shows an alternative embodiment of this invention where second shaking pulses (S2) are placed at any timing in each waveform 1100, 1120, 1140, and 1160, and the timing in different waveforms is different. This approach will further smooth the image update process. The disadvantage of this embodiment is that the time-aligned shaking becomes impossible, leading to lower efficiency. The total image update time is indicated at 1105.

Note that the invention is applicable to both single and multiple window displays, where, for example, a typewriter mode exists. It must be emphasized that, in the above examples, pulse-width modulated (PWM) driving is used for illustrating the invention, i.e., the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. When VM driving or combined VM and PWM driving is used, the compensating pulse is selected such that the energy involved in the compensating pulse is based on the energy difference between the standard reset pulse and the over-reset pulse. This invention is also applicable in color bi-stable displays and the electrode structure is not limited. For example, a top/bottom electrode structure, honeycomb structure or other combined in-plane-switching and vertical switching may be used.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for updating an image on a bi-stable display, the method comprising:
applying at least a first shaking pulse (S1) to at least a portion of the bi-stable display (310, 400);
applying a first portion (R1) of a reset pulse to the at least a portion of the bi-stable display following the at least a first shaking pulse;
applying at least a second shaking pulse (S2) to the at least a portion of the bi-stable display following the first portion of the reset pulse; and
applying a second portion (R2) of the reset pulse to the at least a portion of the bi-stable display following the at least a second shaking pulse.

2. The method of claim 1, wherein:
the second portion of the reset pulse has an over-reset duration.

3. The method of claim 1, wherein:
the first portion of the reset pulse has a standard reset duration.

4. The method of claim 3, wherein:
the standard reset duration is proportional to a distance that particles in the bi-stable display must move to transition from their starting color state, prior to applying the at least a first shaking pulse, to an extreme black or white color state.

5. The method of claim 1, wherein:
an ending point of the first portion of the reset pulse is temporally adjacent to a starting point of the at least a second shaking pulse.

6. The method of claim 1, further comprising:
applying a drive pulse (D) to the at least a portion of the bi-stable display following the second portion of the reset pulse to drive the at least a portion of the bi-stable display to a desired color or greyscale level.

7. The method of claim 1, further comprising:
applying at least a third shaking pulse (S3) to the at least a portion of the bi-stable display following the second portion of the reset pulse;
wherein the at least a third shaking pulse has a shorter pulse width compared to a pulse width of the at least a first shaking pulse and the at least a second shaking pulse.

8. A program storage device tangibly embodying a program of instructions executable by a machine to perform a method for updating an image on a bi-stable display, the method comprising:
applying at least a first shaking pulse (S1) to at least a portion of the bi-stable display (310, 400);
applying a first portion (R1) of a reset pulse to the at least a portion of the bi-stable display following the at least a first shaking pulse;
applying at least a second shaking pulse (S2) to the at least a portion of the bi-stable display following the first portion of the reset pulse; and
applying a second portion (R2) of the reset pulse to the at least a portion of the bi-stable display following the at least a second shaking pulse.

9. An electronic reading device, comprising:
a bi-stable display (310, 400); and
a control (100) for updating an image on the bi-stable display by applying at least a first shaking pulse (S1) to at least a portion of the bi-stable display, applying a first portion (R1) of a reset pulse to the at least a portion of the bi-stable display following the at least a first shaking pulse, applying at least a second shaking pulse (S2) to the at least a portion of the bi-stable display following the first portion of the reset pulse, and applying a second portion (R2) of the reset pulse to the at least a portion of the bi-stable display following the at least a second shaking pulse.

10. The electronic reading device of claim 9, wherein:
the second portion of the reset pulse has an over-reset duration.

11. The electronic reading device of claim 9, wherein:
the first portion of the reset pulse has a standard reset duration.

12. The electronic reading device of claim 11, wherein:
the standard reset duration is proportional to a distance that particles in the bi-stable display must move to transition from their starting color state, prior to applying the first shaking pulse, to an extreme black or white color state.

13. The electronic reading device of claim 9, wherein:
an ending point of the first portion of the reset pulse is temporally adjacent to a starting point of the at least a second shaking pulse.

14. The electronic reading device of claim 9, wherein:
the control applies a drive pulse (D) to at least a portion of the bi-stable display following the second portion of the reset pulse to drive the at least a portion of the bi-stable display to a desired color or greyscale level.

15. The electronic reading device of claim 9, wherein:
the control applies at least a third shaking pulse (S3) to the at least a portion of the bi-stable display following the second portion of the reset pulse; and
the at least a third shaking pulse has a shorter pulse width compared to a pulse width of the at least a first shaking pulse and the at least a second shaking pulse.
